(19) United States
(12) Patent Application Publication
(10) Pub. No.: US 2010/0204427 A1
(43) Pub. Date: Aug. 12, 2010

(54) 10-50 G/D HIGH STRENGTH POLYETHYLENE FIBER AND PREPARATION METHOD THEREOF

(75) Inventor: Yi Ren, Laiwu (CN)

Correspondence Address: KENYON & KENYON LLP, RIVERPARK TOWERS, SUITE 600, 333 W. SAN CARLOS ST., SAN JOSE, CA, 95110, US

(73) Assignee: SHANDONG ICD HIGH PERFORMANCE FIBRES CO., LTD., Laiwu, Shandong (CN)

(21) Appl. No.: 12/600,252

(22) PCT Filed: Jul. 14, 2008
(86) PCT No.: PCT/CN08/01311

§ 371 Date: Nov. 13, 2009

(30) Foreign Application Priority Data
Feb. 26, 2008 (CN) 200810014185.6

(51) Int. Cl. C08F 110/02; D01D 5/12

(52) U.S. Cl. 526/352; 264/210.8

(57) ABSTRACT

A 10-50 g/d high strength polyethylene fiber and preparation method thereof are provided, which are in the high molecular material field. Said fiber is obtained by cross blend melt spinning method, and its strength is 10-50 g/d, its modulus is 400-2000 g/d. The material used by said cross blend melt spinning method is obtained by mixing low density polyethylene with molecular weight of 2/5-500,000 and super molecule weight polyethylene with molecular weight of 120-7000,000 in the proportion of 2-10:1. Flow modifier or diluent is not additionally added in the present invention, raw material consumption is low, extra high pressure is avoided, energy consumption and cost of production are low, technological process is simple, single line capacity is easily raised, and large scale industrial production can be realized.

### BACKGROUND

1. Field of the Invention

The present invention relates generally to polymer materials, and more specifically to a high strength polyethylene (HS-PE) fiber with a tensile strength ranging from 10 to 50 cN/dtex obtained by a preparation method of melt spinning.

2. Description of Related Art

The high strength polyethylene fiber is a well known synthetic fiber with high strength and high elastic modulus, produced from ultrahigh molecular weight polyethylene (UHMWPE) with a molecular weight higher than 1,000,000. Right now, HS-PE fibers, Aramid fibers, and carbon fibers are considered three high performance fibers in the world. Due to its high strength, high modulus and low density, the UHMWPE fiber plays an important role not only in modern warfare, defense equipment and aerospace field, but also in civil fields. The HS-PE fiber is mostly produced by the melt spinning method and the gel spinning ultra-drawing method.

Chinese patent No. CN1539033 discloses an HS-PE fiber with a tensile strength higher than 15 cN/dtex, which is produced by a melt spinning process employing a polyethylene with a weight-average molecular weight lower than 300,000 and a ratio of the weight-average molecular weight to number-average molecular weight (Mw/Mn) less than 4.0 as the starting material. Because of the hyperviscosity, the melt has low fluidity, which makes it difficult to spin and to realize industrial production.

Since late 1970's, the gel spinning ultra-drawing method has been adopted by DSM Company (Netherlands) to realize the industrial production of UHMWPE. In this method, the UHMWPE is resolved by a solvent to relieve flexible polyethylene chain molecules from severe entanglement by the dilution effect. The precursor solution is then extruded from a spinneret hole and quenched to be phase-separated, and new-born gel precursor fibers with folded lamellar crystals and tie-molecule network are obtained. After solvent removing and ultra-after-drawing, final HS-PE fibers with linear chain structure are obtained.

Netherlandish patent NL 7900990 and U.S. Pat. No. 4,344,908 disclose the preparation method of a linear chain structure HS-PE fiber with a tensile strength higher than 35 cN/dtex adopting decalin as a solvent. The spinning solution is prepared by dissolving UHMWPE in decalin. After extruding the precursor solution from a spinneret hole and quenching in air or cold water, new-born gel precursor fibers are obtained. Final HS-PE fibers with a linear chain structure are then obtained by solvent removing and ultra-heat- drawing.

European patents EP0064167 and EP0205960 and U.S. Pat. No. 430,577 disclose preparation methods of linear chain structure HS-PE fibers. The spinning solution is prepared by dissolving UHMWPE in a kerosene or white solvent. After a gel spinning process, extracting, drying and ultra heat-drawing, final HS-PE fibers with a linear chain structure are obtained.

Prior art melt spinning methods for preparing UHMWPE fibers employ UHMWPE as the only raw material, the melt of which causes unfavorable low fluidity. To solve this problem, flow modifiers or diluents as well as a spinning process under ultrahigh pressure are introduced to improve the fluidity, which make industrialization difficult. However, because of the lower orientation of crystallization resulted from the great number of entanglement points of the melt polyethylene chain molecules, HS-PE fibers can be hardly obtained when only PE with low molecular weight is employed.

No published literature on preparing HS-PE fibers with a tensile strength ranging from 10 to 50 cN/dtex and tensile elastic modulus ranging from 400 to 2000 cN/dtex based on the blend-melt-spinning process was found during a prior art search.

### SUMMARY OF THE INVENTION

One objective of the present invention is to provide a blend-melt-spinning method for preparing HS-PE fibers with a tensile strength ranging from 10 to 50 cN/dtex and tensile elastic modulus ranging from 400 to 2000 cN/dtex by adopting UHMWPE and low density polyethylene (PE) as raw materials.

The technical solution of the present invention is as follows:

A high strength polyethylene fiber, wherein said fiber has a tensile strength ranging from 10 to 50 cN/dtex and a tensile elastic modulus ranging from 400 to 2000 cN/dtex, and is prepared by a blend-melt-spinning method.

A high strength polyethylene fiber, wherein said fiber has a tensile strength ranging from 10 to 20 cN/dtex, or

A high strength polyethylene fiber, wherein said fiber has a tensile strength ranging from 20 to 30 cN/dtex, or

A high strength polyethylene fiber, wherein said fiber has a tensile strength ranging from 30 to 40 cN/dtex, or

A high strength polyethylene fiber, wherein said fiber has a tensile strength ranging from 40 to 50 cN/dtex.

When the tensile strength of the HS-PE fiber of the present invention ranges from 15 to 30 cN/dtex, it can be generally used in, but not limited to, the following civil fields: (1) marine engineering, such as ropes, cables, sailing and fishing gears; (2) sports equipment, such as safety helmets, skiing boards, sailing boards, fishing rods, rackets, super-light parts of bicycles, gliding boards, and tip structure of aircrafts; (3) biological materials, for example, fiber reinforced composites in denture materials, medical grafts, plastic surgeries, and other clinical usages due to advantages such as good biocompatibility and durability, high stability and allergies-absence, and medical gloves and other medical facilities as well; and (4) industrial materials: such as pressure vessels, conveyers, filter materials, and car bumpers with the fiber and its composite materials. In addition, the fiber and its composite materials can be used in walls, partition structures and other building materials. The toughness of concrete can be improved when the fiber is used as the reinforced cement composite materials.

When the tensile strength of the HS-PE fiber of the present invention ranges from 30 to 50 cN/dtex, it can be generally applied in, but not limited to, the following fields: (1) defense equipment, such as protective clothing, helmets, bullet-proof materials, helicopters, protective boards of tanks and armored ships, protective shells of radars, missile shield, bullet-proof vests, anti-thorn clothing, and shields; and (2) aerospace applications, such as tip structure of spacecrafts and aircrafts, and hydroplane.

The preparation method of the HS-PE with a tensile strength ranging from 10 to 50 cN/dtex is characterized by adopting UHMWPE and low density PE in different weight ratios as starting materials in a blend-melt-spinning method, wherein said weight ratio of the low density PE and UHMWPE is from 2:1 to 10:1, the weight molecular of the low density PE is between 25,000 and 500,000 and the weight molecular of the UHMWPE ranges from 1,200,000 to 7,000,000.

The preparation process of the HS-PE with a tensile strength ranging from 10 to 50 cN/dtex of the present invention is described in detail as follows:

1) Mixing the Raw Materials

Evenly mixing low density PE and UHMWPE with a weight ratio of 2:1 to 10:1.

2) Blend-Melting

A polyethylene melt is obtained by melting the mixed solution of step 1) in a twin-screw extruder with a temperature between 150 and 300° C.

3) Preparing a New-Born Fiber and Drawing

The obtained polyethylene melt is extruded from a spinning plate of a spinning box, and the spray speed is about 3 to 5 m/min. Subsequently, the new-born fiber is obtained through cooling molding of extruded filatures by a blast apparatus. The cold temperature is maintained between 0 and 35° C. and the wind speed is about 5 to 8 m/s. The new-born fiber is drawn in a godet roller and the draft multiple is 2 to 10 times.

4) Drawing in Two Oil Baths

The new born fiber is transferred into two oil baths filled with glycol by a godet roller and stretched evenly. The temperature of the oil baths may be maintained between 50 and 150° C. The total draft multiple is 3 to 20 times.

5) Removing Oil in a Water Bath

The drafted fiber is washed in a water bath containing heterogeneous alcohol surfactants with a temperature between 60 and 100° C.

6) Drying the Fiber to obtain the HS-PE Fiber

After being washed, the fiber is dried to remove the water and wound onto a tube to get the HS-PE fiber with a tensile strength ranging from 10 to 50 cN/dtex.

The beneficial effects of the product in this invention include:

1) It is unnecessary to introduce flow modifiers or diluents into the melt liquid. According to the mix ratio of the present invention, UHMWPE can enhance the strength of entangle point of the low density PE, which facilitates back-drawing.

2) The HS-FE fiber produced by the present invention possesses a tensile strength ranging from 10 to 50 cN/dtex, tensile elastic modulus ranging from 400 to 2000 cN/dtex and the passing ratio higher than 98%, which can fully satisfy the requirements of civil and military applications.

3) HS-FE fibers with a tensile strength less than 30 cN/dtex prepared by the present invention fill the gaps in the domestic market.

4) In comparison with the prior art, the present invention has advantages such as shorter producing process, simpler equipment requirements, less consumption of raw materials (including the solvent), no ultra-high pressure requirement, lower energy consumption and lower production costs. In addition, it increases the producing capacity due to the single line producing process, which facilitates large-scale industrial production.

### EMBODIMENTS

### Example 1

1) Choice of Raw Materials

UHMWPE with a number-average molecular weight of 6,000,000 and low density PE with a number-average molecular weight of 25,000 are employed as raw materials.

2) Mixing of Raw Materials

A uniform solution is obtained by mixing the low density PE and UHMWPE at a weight ratio of 10:1.

3) Blend-Melting through a Twin-Screw Extruder

A polyethylene melt with a viscosity between 1000 and 3000 Pa·S is obtained by melting the mixture solution of step 2) in a twin-screw extruder with a temperature between 150 and 300° C.

4) New-Born Fiber Preparing and Drawing

The obtained polyethylene melt is extruded from a spinning plate of a spinning box and the spray speed is 3 m/min. Subsequently, a new-born fiber is obtained through cooling molding of extruded filatures by a blast apparatus. The cooling temperature is 20° C. and the wind speed is 5 m/s. The new-born fiber is drawn in a godet roller and the draft multiple is 2 times.

5) Drawing in Two Oil Baths

The new born fiber is transferred into two oil baths filled with glycol by the godet roller and is stretched evenly. The temperature of the first oil bath is 115° C. and the draft multiple is 4 times. The temperature of the second oil bath is 130° C. and the draft multiple is 2 times. The total draft multiple in the two oil baths is 8 times.

6) Oil Removal in a Water Bath

The drafted fiber is washed in a water bath containing heterogeneous alcohol surfactants at 80° C., and the oil is removed from the fiber surface.

7) Drying the Fiber to obtain an HS-PE Fiber

The washed fiber is dried to remove the water and is wound onto a tube to get an HS-PE fiber with a tensile strength of 15 cN/dtex.

It is found in tests that the HS-PE fiber obtained by this process possesses a tensile strength of 10 cN/dtex, a tensile elastic modulus of 400 cN/dtex and the elongation at break is of 3.5%. The passing rate is about 99%.

### Example 2

1) Choice of Raw Materials

UHMWPE with a number-average molecular weight of 5,000,000 and low density PE with a number-average molecular weight of 40,000 are employed as raw materials.

2) Mixing the Raw Materials

A uniform solution is obtained by mixing the low density PE and UHMWPE at a weight ratio of 8:1.

3) Blend-Melting through the Twin-Screw Extruder

A polyethylene melt with a viscosity between 1000 and 3000 Pa·S is obtained by melting the mixture solution of step 2) in a twin-screw extruder with a temperature between 150 and 300° C.

4) New-Born Fiber Preparing and Drawing

The obtained polyethylene melt is extruded from a spinning plate of a spinning box and the spray speed is 5 m/min. Subsequently, a new-born fiber is obtained through cooling molding of extruded filatures by a blast apparatus. The cooling temperature is 35° C. and the wind speed is 8 m/s. The new-born fiber is then drawn in a godet roller and the draft multiple is 4 times.

5) Drawing in Two Oil Baths

The new born fiber is transferred into two oil baths filled with glycol by the godet roller and is stretched evenly. The temperature of the first oil bath is 120° C. and the draft multiple is 3 times. The temperature of the second oil bath is 130° C. and the draft multiple is 3 times.

6) Oil removal in a water bath

The drafted fiber is washed in a water bath containing heterogeneous alcohol surfactants at 95° C.

7) Drying the Fiber to obtain an HS-PE Fiber

The washed fiber is dried to remove water and is wound onto a tube to get an HS-PE fiber with a tensile strength of 20 cN/dtex.

It is found in tests that the HS-PE fiber obtained in this process possesses a tensile strength of 20 cN/dtex, a tensile elastic modulus of 500 cN/dtex and the elongation at break of 2.7%. The passing rate is about 99%.

### Example 3

1) Choice of Raw Materials

UHMWPE with a number-average molecular weight of 5,000,000 and low density PE with a number-average molecular weight of 30,000 are employed as starting materials.

2) Mixing the Raw Materials

A uniform solution is obtained by mixing the low density PE and UHMWPE at a weight ratio of 5:1.

3) Blend-Melting through a Twin-Screw Extruder

A polyethylene melt with a viscosity between 1000 and 3000 Pa·S is obtained by melting the mixture solution of step 2) in a twin-screw extruder with a temperature between 150 and 300° C.

4) New-Born Fiber Preparing and Drawing

The obtained polyethylene melt is extruded from a spinning plate of a spinning box and the spray speed is 4 m/min. Subsequently, a new-born fiber is obtained through cooling molding of extruded filatures by a blast apparatus. The cooling temperature is 25° C. and the wind speed is 6 m/s. The new-born fiber is then drawn in a godet roller and the draft multiple is 5 times.

5) Drawing in Two Oil Baths

The new born fiber is transferred into two oil baths filled with glycol by the godet roller and is stretched evenly. The temperature of the first oil bath is 100° C. and the draft multiple is 3.5 times. The temperature of the second oil bath is 130° C. and the draft multiple is 4 times.

6) Oil Removal in a Water Bath

The drafted fiber is washed in a water bath containing heterogeneous alcohol surfactants at 90° C.

7) Drying the Fiber to obtain an HS-PE Fiber

The washed fiber is dried to remove water and is wound onto a tube to get an HS-PE fiber with a tensile strength of 30 cN/dtex.

It is found in tests that the HS-PE fiber obtained in this process possesses a tensile strength of 30 cN/dtex, a tensile elastic modulus of 980 cN/dtex and the elongation at break of 2.8%. The passing rate is about 98%.

### Example 4

1) Choice of Raw Materials

UHMWPE with a number-average molecular weight of 4,000,000 and low density PE with a number-average molecular weight of 30,000 are employed as raw materials.

2) Mixing the Raw Materials

A uniform solution is obtained by mixing the low density PE and UHMWPE at a weight ratio of 4:1.

3) Blend-Melting through a Twin-Screw Extruder

A polyethylene melt with a viscosity between 1000 and 3000 Pa·S is obtained by melting the mixture solution of step 2) in a twin-screw extruder with a temperature between 150 and 300° C.

4) New-Born Fiber Preparing and Drawing

The obtained polyethylene melt is extruded from a spinning plate of a spinning box and the spray speed is 4 m/min. Subsequently, a new-born fiber is obtained through cooling molding of extruded filatures by a blast apparatus. The cooling temperature is 25° C. and the wind speed is 6 m/s. The new-born fiber is then drawn in a godet roller and the draft multiple is 5 times.

5) Drawing in Two Oil Baths

The new born fiber is transferred into two oil baths filled with glycol by the godet roller and is stretched evenly. The temperature of the first oil bath is 115° C. and the draft multiple is 4 times. The temperature of the second oil bath is 130° C. and the draft multiple is 4 times.

6) Oil Removal in a Water Bath

The drafted fiber is washed in a water bath containing heterogeneous alcohol surfactants at 90° C.

7) Drying the Fiber to obtain an HS-PE Fiber

The washed fiber is dried to remove water and is wound onto a tube to get an HS-PE fiber with a tensile strength of 40 cN/dtex.

It is found in tests that the HS-PE fiber obtained in this process possesses a tensile strength of 40 cN/dtex, a tensile elastic modulus of 1500 cN/dtex and the elongation at break of 2.9%. The passing rate is about 98.5%.

### Example 5

1) Choice of Raw Materials

UHMWPE with a number-average molecular weight of 5,000,000 and low density PE with a number-average molecular weight of 30,000 are employed as raw materials.

2) Mixing the Raw Materials

A uniform solution is obtained by mixing the low density PE and UHMWPE at a weight ratio of 3.5:1.

3) Blend-Melting through a Twin-screw Extruder

A polyethylene melt with a viscosity between 1000 and 3000 Pa·S is obtained by melting the mixture solution of step 2) in a twin-screw extruder with a temperature between 150 and 300° C.

4) New-Born Fiber Preparing and Drawing

The obtained polyethylene melt is extruded from a spinning plate of a spinning box and the spray speed is 4 m/min. Subsequently, a new-born fiber is obtained through cooling molding of extruded filatures by a blast apparatus. The cooling temperature is 20° C. and the wind speed is 6 m/s. The new-born fiber is then drawn in a godet roller and the draft multiple is 5 times.

5) Drawing in Two Oil Baths

The new born fiber is transferred into two oil baths filled with glycol by the godet roller and is stretched evenly. The temperature of the first oil bath is 115° C. and the draft multiple is 4 times. The temperature of the second oil bath is 130° C. and the draft multiple is 5 times.

6) Oil Removal in a Water Bath

The drafted fiber is washed in a water bath containing heterogeneous alcohol surfactants at 90° C.

7) Drying the Fiber to obtain an HS-PE Fiber

The washed fiber is dried to remove water and is wound onto a tube to get an HS-PE fiber with a tensile strength of 50 cN/dtex.

It is found in tests that the HS-PE fiber obtained in this process possesses a tensile strength of 50 cN/dtex, a tensile elastic modulus of 1800 cN/dtex and the elongation at break of 2.7%. The passing rate is about 99%.

The above-mentioned embodiments are only used to illustrate the present invention, not intended to limit the scope thereof. Many modifications of the embodiments can be made without departing from the spirit of the present invention.

1. A high strength polyethylene (HS-PE) fiber, wherein said fiber is obtained by a blend melt spinning method, a tensile strength of said fiber ranges from 10 to 50 cN/dtex and a tensile elastic modulus of said fiber ranges from 400 to 2000 cN/dtex.

2. The high strength polyethylene fiber according to claim 1, wherein the tensile strength ranges from 10 to 20 cN/dtex.

3. The high strength polyethylene fiber according to claim 1, wherein the tensile strength ranges from 20 to 30 cN/dtex.

4. The high strength polyethylene fiber according to claim 1, wherein the tensile strength ranges from 30 to 40 cN/dtex.

5. The high strength polyethylene fiber according to claim 1, wherein the tensile strength ranges from 40 to 50 cN/dtex.

6. A method for preparing an HS-PE fiber with a tensile strength ranging from 10 to 50 cN/dtex, comprising: using low density polyethylene (PE) and ultrahigh molecular weight polyethylene (UHMWPE) as raw materials at a weight ratio in a blend-melt-spinning method, wherein said weight ratio of the low density PE and UHMWPE is from 2:1 to 10:1, a weight molecular of the low density PE is between 25,000 and 200,000, and a weight molecular of the UHMWPE is from 1,200,000 to 7,000,000.

7. The method according to claim 6, further comprising:
mixing the low density PE and UHMWPE to obtain a mixture solution;
melting the mixture solution in a twin-screw extruder with a temperature between 150 and 300° C. to obtain a polyethylene melt;
extruding the polyethylene melt from a spinning plate of a spinning box at a spray speed of about 3 to 5 m/min;
obtaining a new-born fiber through cooling molding of extruded filatures by a blast apparatus, wherein a cooling temperature is maintained between 0 and 35° C. and a wind speed is about 5 to 8 m/s;
drawing the new-born fiber in a godet roller, wherein a draft multiple is 2 to 6 times;
transferring the new born fiber into two oil baths filled with glycol by the godet roller and stretching the new born fiber evenly, wherein a temperature of an oil bath is maintained between 50 and 150° C., and a total draft multiple is 3 to 20 times;
washing the drafted fiber in a water bath containing heterogeneous alcohol surfactants with a temperature between 60 and 100° C.; and
drying the washed fiber to remove water and winding the dried fiber onto a tube.

8. (canceled)

9. (canceled)

10. A method for preparing an HS-PE fiber with a tensile strength ranging from 10 to 50 cN/dtex, comprising: using low density PE and UHMWPE as raw materials at a weight ratio from 2:1 to 10:1 in a blend-melt-spinning method.

11. The method of claim 10, further comprising:
mixing the low density PE and UHMWPE to obtain a mixture solution; and
melting the mixture solution to obtain a polyethylene melt.

12. The method of claim 11, wherein the mixture solution is melt in a twin-screw extruder with a temperature between 150 and 300° C.

13. The method of claim 11, further comprising: extruding the polyethylene melt.

14. The method of claim 13, wherein the polyethylene melt is extruded from a spinning plate of a spinning box at a spray speed of about 3 to 5 m/min.

15. The method of claim 13, further comprising: obtaining a new-born fiber through cooling molding of extruded filatures.

16. The method of claim 15, wherein the cooling molding is done by a blast apparatus, wherein a cooling temperature is maintained between 0 and 35° C.

17. The method of claim 15, further comprising: drawing the new-born fiber.

18. The method of claim 17, wherein the new-born fiber is drawn in a godet roller, wherein a draft multiple is 2 to 6 times.

19. The method of claim 17, further comprising: transferring the new born fiber into an oil bath.

20. The method of claim 19, wherein the oil bath is filled with glycol and wherein a temperature of the oil bath is maintained between 50 and 150° C.
